(19) United States
(12) Patent Application Publication
(10) Pub. No.: US 2001/0009744 A1
(43) Pub. Date: Jul. 26, 2001

(54) Electrolyte for lithium secondary battery and lithium secondary battary comprising same

(76) Inventors: Jin-Sung Kim, Seoul (KR); Jong-Wook Lee, Cheonan-city (KR); Kwang-Sik Kim, Cheonan-city (KR); Young-Gyu Kim, Taejeon-city (KR); Je-Yun Kim, Taejeon-city (KR); Jong-Seob Kim, Taejeon-city (KR)

Correspondence Address: CHRISTIE, PARKER & HALE, LLP, P. O. Box 7068, Pasadena, CA, 91109-7068, US

(21) Appl. No.: 09/766,520

(22) Filed: Jan. 19, 2001

(30) Foreign Application Priority Data
Jan. 21, 2000 (KR) 2000-2947
Dec. 23, 2000 (KR) 2000-81253

(51) Int. Cl. H01M 6/16; H01M 10/40

(52) U.S. Cl. 429/326; 429/340; 429/231.95

(57) ABSTRACT

Disclosed is an electrolyte for a lithium secondary battery. The electrolyte includes a non-aqueous solvent and a sulfone based organic compound represented as in the following Formulae (I), (II), or (III), or a mixture thereof:

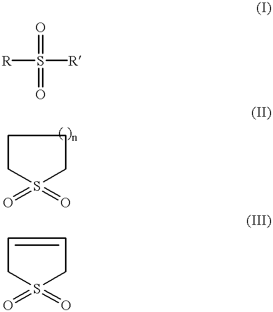

where R and R′ are independently selected from the group consisting of a primary, secondary, or tertiary alkyl group, alkenyl group, and aryl group; and a substituted primary, secondary, or tertiary alkyl group, alkenyl group, and aryl group, and n is from 0 to 3.

### CROSS REFERENCE TO RELATED APPLICATION

This application is based on application Nos. 2000-2947 & 2000-81253 respectively filed in the Korean Industrial Property Office on Jan. 21, 2000, & Dec. 23, 2000 the content of which is incorporated hereinto by reference.

### BACKGROUND OF THE INVENTION

(a) Field of the Invention

The present invention relates to an electrolyte for a lithium secondary battery and a lithium secondary battery, and more particularly, to an electrolyte for a lithium secondary battery capable of preventing a thickness of the battery from being expanded when the battery is charged at room temperature or when the battery is stored at a high temperature after charging, and a lithium secondary battery comprising the same.

(b) Description of the Related Art

The use of portable electronic instruments is increasing as electronic equipment gets smaller and lighter due to developments in high-tech electronic industries. Studies on lithium secondary batteries are actively being pursued in accordance with the increased need for a battery having a high energy density for use as a power source in these portable electronic instruments. Lithium-transition metal oxides are used as a positive active material of a lithium secondary battery, and lithium metals, lithium alloys, crystalline or amorphous carbons, or carbon composites are used as a negative active material of a lithium secondary battery.

An average discharge voltage of a lithium secondary battery is about 3.6 to 3.7 V, which is higher than other alkali batteries, Ni-MH batteries, Ni-Cd batteries, etc. However, an electrolyte which is electrochemically stable in the charge and discharge voltage range of 0 to 4.2 V is required in order to generate such a high driving voltage. Because of this reason, a mixture of non-aqueous carbonate based solvents such as ethylene carbonate, dimethyl carbonate, diethyl carbonate, etc. is used as an electrolyte. However, such electrolyte has a significantly lower ion conductivity than an aqueous electrolyte which is used in a Ni-MH battery or Ni-Cd battery, thereby resulting in the deterioration of battery characteristics during charging and discharging at high rate.

During the initial charge of a lithium secondary battery, lithium ions, which are released from a lithium-transition metal oxides positive electrode of the battery, are transferred to a carbon negative electrode where the ions are intercalated into the carbon. Because of its high reactivity, lithium is reacted with the carbon negative electrode to produce Li₂CO₃, LiO, LiOH, etc., thereby forming a thin film on a surface of the negative electrode. This film is referred to as a solid electrolyte interface (SEI) film. The SEI film formed during the initial charge not only prevents the reaction between lithium ions with the carbon negative electrode or other materials during charging and discharging, but also acts as an ion tunnel, allowing the passage of only lithium ions. The ion tunnel prevents the disintegration of the structure of the carbon negative electrode, which is caused that organic solvents in an electrolyte with a high molecular weight make to solvate lithium ion and the solvent and the solvated lithium ion are co-intercalated into the carbon negative electrode.

Once the SEI film is formed, lithium ions are again not side reacted with the carbon electrode or other materials such that an amount of lithium ions is maintained. That is, carbon of the negative electrode reacts with an electrolyte during the initial charging, thus forming a passivation layer such as a SEI film on the surface of the negative electrode such that the electrolyte solution is no longer decomposed, and stable charging and discharging are maintained (J. Power Sources, 51(1994), 79-104). Because of these reasons, in the lithium secondary battery, an irreversible formation reaction of the passivation layer does not occur and a stable cycle life after the initial charging reaction is maintained.

In the case of a thin prismatic battery, there occurs a problem in which gases are generated inside the battery since a carbonate based organic solvent is decomposed during the SEI film forming reaction (J. Power Sources, 72(1998), 66-70). These gases include H₂, CO, CO₂, CH₄, CH₂, C₂H₆, C₃H₈, C₃H₆, etc. depending on the type of non-aqueous organic solvent and negative active material used. The thickness of the battery is expanded during charging due to the generation of gas inside the battery, and a passivation layer is slowly disintegrated by electrochemical energy and heat energy which increase with the passage of time when the battery is stored at high temperatures after it is charged. Accordingly, a side reaction in which an exposed surface of the negative electrode is reacted with surrounding electrolyte occurs continuously. Furthermore, an internal pressure of the battery is increased with this generation of gas. The increase in the internal pressure induces the deformation of the prismatic battery and lithium polymer battery (PLI). As a result, regional differences in the cohesion between pole plates inside an electrode element (positive and negative electrode, and separator) of the battery occur, thereby deteriorating the performance and stability of the battery and making the mounting of the lithium secondary battery set itself difficult.

As a method for solving the internal pressure problem, there is disclosed a method in which the stability of a secondary battery including a non-aqueous electrolyte is improved by mounting a vent or a current breaker for ejecting an internal electrolyte solution when the internal pressure is increased above a certain level. However, a problem with this method is that mis-operation may be caused by an increase in internal pressure itself.

Furthermore, a method in which the SEI forming reaction is changed by injecting additives into an electrolyte so as to inhibit the increase in internal pressure is known. For example, Japanese Patent Laid-open Publication No. 97-73918A discloses a method in which high temperature storage characteristics of a battery are improved by adding a diphenyl picrylhydrazyl compound of 1% or less to the electrolyte. Japanese Patent Laid-open Publication No. 96-321312A discloses a method in which cycle life and long term storage characteristics are improved using a N-butyl amine group compound of 1 to 20% in an electrolyte. Japanese Patent Laid-open Publication No. 96-64238A discloses a method in which storage characteristics of a battery are improved by adding 3×10⁻⁴ to 3×10⁻³ M of calcium salt to the electrolyte. Japanese Patent Laid-open Publication No. 94-333596A discloses a method in which storage characteristics of a battery are improved by adding an azo compound to inhibiting the reaction between an electrolyte and a negative electrode of the battery.

Such methods as described above for inducing the formation of an appropriate film on a negative electrode surface such as a SEI film by adding a small amount of organic or inorganic materials are used in order to improve the storage characteristics and stability of a battery. However, there are various problems with these methods: the added compound is decomposed or forms an unstable film by interacting with the carbon negative electrode during initial charging and discharging according to inherent electrochemical characteristics, resulting in the deterioration of the ion mobility in an electron; gas is generated inside the battery such that there is an increase in internal pressure, resulting in the significant worsening of the storage characteristics, stability, cycle life, and capacity of the battery.

### SUMMARY OF THE INVENTION

It is an object of the present invention to provide an electrolyte for a lithium secondary battery including a sulfone based organic compound which is capable of inhibiting the generation of gas inside the battery caused by the decomposition of a carbonate based organic solvent during initial charging.

It is another object of the present invention to provide a lithium secondary battery that undergoes almost no variation in thickness when the battery is charged at room temperature or when the battery is stored at a high temperature after charging.

In order to accomplish the objects of the present invention, the present invention provides an electrolyte for a lithium secondary battery. The electrolyte includes a non-aqueous organic solvent and a sulfone based organic compound selected from the group consisting of a compound represented as in the following Formulae (I), (II), or (III), and a mixture thereof:

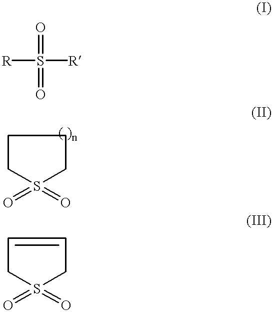

where R and R′ are independently selected from the group consisting of a primary, secondary, or tertiary alkyl group, alkenyl group, and aryl group; and a substituted primary, secondary, or tertiary alkyl group, alkenyl group, and aryl group, and n is from 0 to 3.

The present invention further provides a lithium secondary battery including the electrolyte, a positive electrode including lithium-transition metal oxides as a positive active material and a negative electrode including carbon, carbon composite, lithium metal, or lithium alloy as a negative active material.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawing, wherein:

FIG. 1 is a graph illustrating cycle life characteristics of the cells according to Examples 2, 7 and 8 and Comparative Example 1 of the present invention.

### DETAILED DESCRIPTION OF THE INVENTION

In the following detailed description, only the preferred embodiment of the invention has been shown and described, simply by way of illustration of the best mode contemplated by the inventors of carrying out the invention. As will be realized, the invention is capable of modification in various obvious respects, all without departing from the invention. Accordingly, the drawings and description are to be regarded as illustrative in nature, and not restrictive.

An electrolyte of the present invention is prepared by adding a sulfone based organic compound to a non-aqueous carbonate based organic solvent. A sulfone based organic compound represented as in the following Formulae (I), (II), or (III), or a mixture thereof can be used in the present invention:

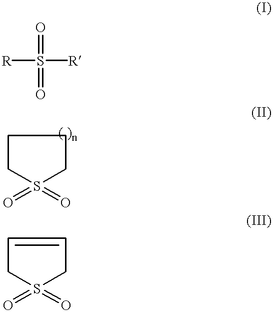

where R and R′ are independently selected from the group consisting of a primary, secondary, or tertiary alkyl group, alkenyl group, and aryl group; and a substituted primary, secondary, or tertiary alkyl group, alkenyl group, and aryl group, and n is from 0 to 3. R and R′ are preferably an alkyl group of C₁ to C₄, an alkenyl group of C₂ to C₄, or an aryl group of C₆ to C₁₄, a substituted alkyl group of C₁ to C₄, a substituted alkenyl group of C₂ to C₄, or a substituted aryl group of C₆ to C₁₄, and the substituent is preferably halogen selected from the group consisting of fluoro, chloro, bromo, and iodo. Specific examples of a sulfone based organic compound preferably used in the present invention include methyl sulfone, vinyl sulfone, phenyl sulfone, 4-fluorophenyl sulfone, benzyl sulfone, tetramethylene sulfone, and butadiene sulfone.

A sulfone based organic compound is added to a non-aqueous organic solvent in an amount of 0.1 to 10 weight %, preferably 0.1 to 5 weight % of the total amount of the electrolyte. The effect of inhibiting the generation of gas inside a battery is not likely when the sulfone based organic compound is used in an amount of less than 0.1 weight %. Initial charge and discharge efficiencies and a cycle life performance of the battery are decreased in accordance with the increase in the amount of compound used when the sulfone based organic compound is used in an amount exceeding 10 weight %.

The sulfone based organic compound is decomposed earlier than a carbonate based organic solvent during initial charging to react with lithium ions resulting in the formation of a SEI film, thereby inhibiting the decomposition of the carbonate based organic solvent. Therefore, the increase in the thickness of a prismatic battery or lithium polymer battery can be prevented during charging at room temperature or during high temperature storage after charging since the generation of gas caused by the decomposition of the carbonate based organic solvent is inhibited during initial charging.

The carbonate based organic solvent such as a cyclic or chained carbonate, or a mixture of two or more solvents can be used as a non-aqueous organic solvent in the present invention. Specific examples of the non-aqueous organic solvent include ethylene carbonate (EC), dimethyl carbonate (DMC), diethyl carbonate (DEC), and methylethyl carbonate (MEC).

Lithium hexafluorophosphate (LiPF₆), lithium tetrafluoroborate (LiBF₄), lithium perchlorate (LiClO₄), lithium trifluoromethariesulfonate (CF₃SO₃Li), lithium hexafluoroarsenate (LiAsF₆), or a mixture thereof is added to the electrolyte as a supporting salt. These act in a battery as a supplying source of lithium ions, making the basic operation of a lithium secondary battery possible.

An electrolyte for a lithium secondary battery of the present invention is stable in the temperature range of −20 to 60° C., thereby maintaining stable characteristics of the battery even at a voltage of 4 V. An electrolyte of the present invention can be applied to all lithium secondary batteries including a lithium ion battery, lithium polymer battery, etc.

Lithium-transition metal oxides such as LiCoO₂, LiNiO₂, LiMnO₂, LiMn₂O₄, or LiNi_{1-x-y}CoₓM_{y}O₂ (wherein 0≦x ≦1, 0≦y 1, 0≦x+y ≦1, and M is a metal such as Al, Sr, Mg, La, etc.) are used as a positive active material, and crystalline or amorphous carbon such as mesocarbon fiber (MCF), carbon composite, lithium metal, or lithium alloy is used as a negative active material in a lithium secondary battery of the present invention.

A lithium secondary battery is manufactured by placing the electrode element into a can or similar container and then injecting a non-aqueous electrolyte solution to which the sulfone based organic compound is added into the can or container after preparing the electrode groups by coating the active material to a suitable thickness and length on a collector of a thin plate or coating the active material itself in a form of film. Subsequently, the coated material or film is rolled up or laminated along with a dielectric separator. Resins film such as polyethylene, polypropylene, etc. can be used as the separator.

The following Examples further illustrate the present invention in detail but are not to be construed to limit the scope thereof.

### EXAMPLES 1 TO 10

Electrolytes of Examples 1 to 10 were prepared by adding 1 M of LiPF₆ to a non-aqueous organic solvent in which ethylene carbonate (EC) and dimethyl carbonate (DMC) are mixed in a volume ratio of 1:1, and then adding sulfone based organic compounds as shown in the Table 1 to the solvent.

TABLE 1

| | | Added amount |
|---|---|---|
| | Sulfone based organic compound | (weight %) |
| Example 1 | Methyl sulfone | 2 |
| Example 2 | Vinyl sulfone | 2 |
| Example 3 | Phenyl sulfone | 2 |
| Example 4 | 4-Fluorophenyl sulfone | 2 |
| Example 5 | Butadiene sulfone | 2 |
| Example 6 | Tetramethylene sulfone | 2 |
| Example 7 | Vinyl sulfone | 1 |
| Example 8 | Vinyl sulfone | 5 |
| Example 9 | Phenyl sulfone | 1 |
| Example 10 | 4-Fluorophenyl sulfone | 1 |

### COMPARATIVE EXAMPLE 1

1 M of LiPF₆ was added to a non-aqueous organic solvent in which ethylene carbonate (EC) and dimethyl carbonate (DMC) are mixed in a volume ratio of 1:1 to prepare an electrolyte for a rechargeable lithium battery.

### Measuring of Decomposition Voltage

Decomposition voltages of the electrolytes of the Examples 1 to 6 and Comparative example 1 were measured by a cyclic voltametry process. The results are represented in the following Table 2.

TABLE 2

| | Decomposition voltage(V) |
|---|---|
| Example 1 | 0.6 |
| Example 2 | 1.3 |
| Example 3 | 1.1 |
| Example 4 | 1.06 |
| Example 5 | 0.6 |
| Example 6 | 0.8 |
| Comparative Example 1 | 0.5 |

The conditions for measuring the cyclic voltages were as follows:

Working electrode: MCF, reference electrode: Li-metal, counter electrode: Li-metal, voltage range: 3 V to 0 V, scan rate: 0.1 mV/s.

The electrolytes of Examples 1 to 6 to which sulfone based organic compounds were added have higher decomposition voltages than the electrolyte of Comparative example 1 to which the sulfone based organic compounds are not added. Accordingly, the electrolytes of Example 1 to 6 decompose earlier during initial charging, and a SEI film forming reaction occurs at the decomposition voltage.

### Manufacturing of Lithium Secondary Batteries

After mixing LiCoO₂ as a positive active material, polyvinylidenefluoride (hereinafter referred to as “PVDF”) as a binder, and acetylene black as a conductive agent in a weight ratio of 92:4:4, a positive slurry was prepared by dispersing the mixture into N-methyl-2-pyrrolidone. The slurry was coated on a 20 μm thick aluminum foil, dried, and compressed, thereby manufacturing a positive electrode. After mixing crystalline artificial graphite as a negative active material with PVDF as a binder in a weight ratio of 92:8, a negative slurry was prepared by dispersing the mixture into N-methyl-2-pyrrolidone. The slurry was coated on a 15 μm thick copper foil, dried, and compressed, thereby manufacturing a negative electrode. Together with a 25 μm thick polyethylene separator, the manufactured electrodes were wound, and pressed, then placed into prismatic cans having the dimensions of 30 mm×48 mm×6 mm. Each of the electrolytes of the Examples 1 to 10 and Comparative example 1 were injected into the cans, thereby completing the manufacture of the batteries.

### Thickness Variations in the Batteries After Charging

The lithium secondary batteries, which were manufactured by injecting the electrolyte solutions of the Examples 1 to 10 and Comparative example 1, were charged with an electric current of 160 mA to a charge voltage of 4.2 V under the condition of CC-CV then allowing the batteries to sit for 1 hour, and the batteries were discharged to 2.5 V with an electric current of 160 mA and left to sit for 1 hour. After repeating this procedure 3 times, the batteries were charged with an electric current of 600 mA to a charge voltage of 4.2 V for 2 hours and 30 minutes. The rates of increase in the thicknesses of the batteries after charging (relative to the thicknesses measured after assembly of the batteries) are represented in the Table 3.

TABLE 3

| | Thickness variation of battery after charging |
|---|---|
| Example 1 | 6.9% |
| Example 2 | 3.4% |
| Example 3 | 5.3% |
| Example 4 | 3.6% |
| Example 5 | 6.4% |
| Example 6 | 7.4% |
| Example 7 | 4.5% |
| Example 8 | 3.4% |
| Example 9 | 6.1% |
| Example 10 | 4.5% |
| Comparative Example 1 | 7.9% |

### Thickness Variations of the Batteries During High Temperature Storage After Charging

The lithium secondary batteries, which were manufactured by injecting the electrolytes of the Examples 1 to 6, 9 and 10 and Comparative example 1, were placed in a chamber of high temperature (85° C.) for 4 days and the thicknesses of the batteries were measured every 24 hours. The rates of increase in the thicknesses of the batteries (relative to the thicknesses measured after assembly) are represented in the following Table 4.

TABLE 4

| | 4 hours | 24 hours | 48 hours | 72 hours | 96 hours |
|---|---|---|---|---|---|
| Example 1 | 17.2% | 20.9% | 23.3% | 27.3% | 31.4% |
| Example 2 | 7.9% | 12.6% | 16.7% | 21.1% | 25.5% |
| Example 3 | 17.8% | 25.3% | 27.6% | 29.7% | 31.9% |
| Example 4 | 7.8% | 15.3% | 21.6% | 23.7% | 25.9% |
| Example 5 | 17.6% | 22.8% | 27.2% | 30.2% | 33.1% |
| Example 6 | 17.4% | 20.7% | 22.1% | 26.3% | 30.5% |
| Example 9 | 17.6% | 22.8% | 27.2% | 30.2% | 33.1% |
| Example 10 | 8.9% | 20.6% | 23.2% | 25.1% | 28.5% |
| Comparative | 22.9% | 28.1% | 30.9% | 33.2% | 35.5% |
| Example 1 | | | | | |

It is evident from the Tables 3 and 4 that the increases in thickness of the lithium secondary batteries into which the electrolytes of Examples 1 to 6, 9 and 10 were injected is substantially less than that of the lithium secondary battery into which the electrolyte solution of Comparative example 1 was injected.

### Cycle Life Characteristics

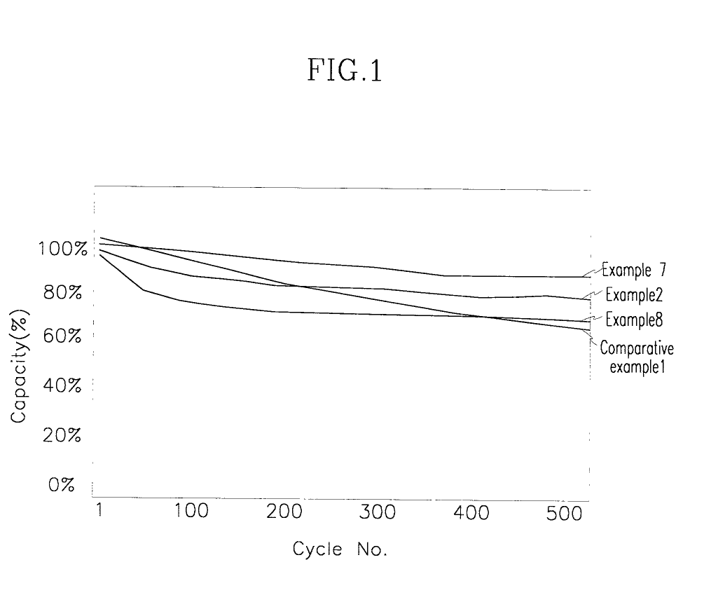

The lithium secondary batteries, which were manufactured by injecting the electrolyte solutions of the Examples 2, 7 and 8 and Comparative example 1, were charged at 1 C rate to a charge voltage of 4.2 V under the condition of CC-CV, and the batteries were discharged at 1 C to 2.75 V. The cycle life characteristics of the cells according to Examples 2, 7 and 8, and Comparative example 1 were measured and the results are shown in FIG. 1. As shown in FIG. 1, the capacity of the cell of Comparative example 1 is significantly reduced during the charge and discharge cycles, but that of Examples 2, 7 and 8 is nearly not reduced. Accordingly, the cycle life characteristics of the cells of Examples 2, 7 and 8 are better than that of Comparative example 1.

A sulfone based organic compound added to an electrolyte of the present invention is decomposed earlier than a carbonate based organic solvent during initial charging, thus forming a SEI film to inhibit a carbonate based organic solvent from being decomposed. Therefore, a lithium secondary battery to which the electrolyte of the present invention is applied decreases the internal pressure of batteries and prevents the thickness of batteries from increasing during charging at room temperature or during high temperature storage after charging. That is, these effects are realized by inhibiting the generation of gas caused by the decomposition of the carbonate based organic solvent during initial charging.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. An electrolyte for a lithium secondary battery comprising:
a non-aqueous organic solvent; and
a sulfone based organic compound selected from the group consisting of a compound represented as in the following Formulae (I), (II), or (III), and a mixture thereof: 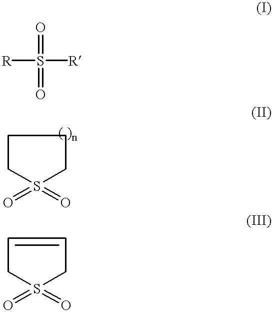
where R and R′ are independently selected from the group consisting of a primary, secondary, or tertiary alkyl group, alkenyl group, and aryl group; and a substituted primary, secondary, or tertiary alkyl group, alkenyl group, and aryl group, and n is from 0 to 3.

2. The electrolyte for a lithium secondary battery according to claim 1, wherein the substituent is halogen selected from the group consisting of fluoro, chloro, bromo, and odo.

3. The electrolyte for a lithium secondary battery according to claim 1, wherein the sulfone based organic compound is selected from the group consisting of methyl sulfone, vinyl sulfone, phenyl sulfone, 4-fluorophenyl sulfone, benzyl sulfone, tetramethylene sulfone, and butaidiene sulfone.

4. The electrolyte for a lithium secondary battery according to claim 1, wherein the amount of the sulfone based organic compound is 0.1 to 10 weight %.

5. A lithium secondary battery comprising:
an electrolyte comprising a non-aqueous organic solvent and a sulfone based organic compound selected from the group consisting of a compound represented as in the following Formulae (I), (II), or (III), and a mixture thereof;
a positive electrode including lithium-transition metal oxides as a positive active material; and
a negative electrode including carbon, carbon composite, lithium metal, or lithium alloy as a negative active material: 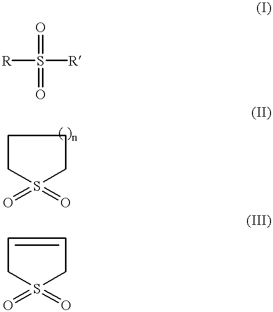
where R and R′ are independently selected from the group consisting of a primary, secondary, or tertiary alkyl group, alkenyl group, and aryl group; and a substituted primary, secondary, or tertiary alkyl group, alkenyl group, and aryl group, and n is from 0 to 3.
